(19) United States
(12) Patent Application Publication
(10) Pub. No.: US 2025/0379247 A1
(43) Pub. Date: Dec. 11, 2025

(54) MULTILAYERED ANION EXCHANGE MEMBRANE WITH ENHANCED INTERFACE PROPERTIES FOR ELECTROCHEMICAL DEVICES

(71) Applicant: HET HYDROGEN PTE. LTD., ENTERPRISE HUB (SG)

(72) Inventors: Zhijun Gu, Shanghai (CN); Arthur Ernest Koschany, Shanghai (CN)

(21) Appl. No.: 18/966,603

(22) Filed: Dec. 3, 2024

(30) Foreign Application Priority Data
Jun. 5, 2024 (CN) 202410721246.1

(51) Int. Cl. H01M 8/1053; C25B 13/02; H01M 8/1062; H01M 8/1086

(52) U.S. Cl. CPC H01M 8/1053; C25B 13/02; H01M 8/1062; H01M 8/109; H01M 8/1093

(57) ABSTRACT

The present disclosure pertains to a multilayered membrane, such as an anion exchange membrane (AEM), optimized for use in various electrochemical devices. The AEM features a unique multilayered structure comprising a core layer and one or more surface layers, each designed to enhance the interface with the catalyst layer. The surface layers are distinguished by their different water uptake capacity, and increased adhesiveness, and better chemical stability compared to the core layer, attributes that are critical for improving ion transport and membrane performance. The surface layers also exhibit a lower degree of cross-linking and a higher ion exchange capacity (IEC) than the core layer. The versatile construction of the AEM allows for configurations tailored to specific applications, including electrolyzers, fuel cells, and reversible fuel cells. This disclosure promises significant advancements in electrochemical device technology, contributing to the development of efficient and sustainable energy solutions.

### CROSS-REFERENCE TO RELATED APPLICATIONS

This application claims the benefit of Chinese Patent Application No. 202410721246.1, filed on Jun. 5, 2024. The entire disclosure of the above application is incorporated herein by reference.

### FIELD

The present technology relates to advancements in electrochemical device components and, more specifically, the construction of anion exchange membranes for electrochemical devices.

### INTRODUCTION

This section provides background information related to the present disclosure which is not necessarily prior art.

Electrochemical devices such as electrolyzers, fuel cells, and reversible fuel cells are critical in the advancement of sustainable energy technologies. These devices rely on the efficient conversion of chemical energy into electrical energy and vice versa, a process that is significantly influenced by the performance of the anion exchange membrane (AEM) employed within the system. The AEM is a pivotal component that facilitates ion transport while preventing the mixing of reactants, thereby ensuring the device operates effectively.

Historically, the development of AEMs has faced challenges in balancing the need for high ion conductivity with the mechanical and chemical stability required for long-term operation. Traditional AEMs often suffer from inadequate hydration, which can impede ion transport and reduce the overall efficiency of the electrochemical device. Moreover, the interaction between the membrane and the catalyst layer has been a focal point for improvement, as poor adhesion at this interface can lead to increased resistance and diminished performance.

Recent advancements in AEM technology have sought to address these issues by introducing membranes with improved water uptake capacities and enhanced adhesion properties. However, many of these solutions have introduced complexities in the manufacturing process or have resulted in membranes that do not adequately meet the durability requirements for commercial and industrial applications. There remains a need for an AEM that not only exhibits superior ion transport and mechanical properties but also can be produced in a cost-effective and scalable manner.

Furthermore, the integration of AEMs into various electrochemical applications has highlighted the need for versatile membrane designs that can be tailored to specific device configurations. The ability to customize the membrane structure, such as the arrangement of surface and core layers in relation to the catalyst or electrode, is essential for optimizing device performance across a range of applications. Current AEM designs often lack this versatility, leading to a compromise in device efficiency or a restriction in the scope of their applicability.

Accordingly, there is a continuing need for an AEM that provides not only improved hydration and adhesion characteristics but also exhibits the flexibility, durability, and ease of manufacturing required to advance the field of electrochemical devices. Desirably, such a membrane would overcome the limitations of current technologies while supporting the diverse requirements of modern sustainable energy systems.

### SUMMARY

In concordance with the instant disclosure, an AEM that provides not only improved hydration and adhesion characteristics but also exhibits the flexibility, durability, and ease of manufacturing required to advance the field of electrochemical devices, and which overcomes the limitations of current technologies while supporting the diverse requirements of modern sustainable energy systems, has surprisingly been discovered.

The present technology includes articles of manufacture, systems, and processes that relate to electrochemical devices and, more particularly, to anion exchange membranes used within such devices. Specifically, the technology pertains to the design and construction of multilayered anion exchange membranes with differentiated surface and core layers, which exhibit enhanced properties for improved interface with catalysts, increased ion transport efficiency, and adaptability to various electrochemical applications including electrolyzers, fuel cells, and reversible fuel cells.

In one embodiment, the disclosure describes a multilayered membrane designed for electrochemical devices, which includes a core layer and at least one surface layer. The surface layer is specifically engineered to improve the interface with a catalyst layer by offering at least one of a different water uptake capacity, and greater adhesiveness compared to the core layer, and a chemical stability towards conditions during operation that is greater than the chemical stability of the core layer, thereby enhancing the performance of the membrane in the device.

In another embodiment, a method for manufacturing a multilayered membrane is provided, which involves forming a core layer and applying at least one surface layer over the core layer. This surface layer is tailored to boost the interface with a catalyst layer, characterized by at least one of a different water uptake capacity, and increased adhesiveness relative to the core layer, and a chemical stability towards conditions during operation that is greater than the chemical stability of the core layer, contributing to the improved functionality of the multilayered membrane.

In a further embodiment, an electrochemical device is presented, comprising an anode plate, an anode electrode, a cathode electrode, a cathode plate, and a multilayered membrane that includes a core layer and at least one surface layer. The surface layer is designed to augment the interface with a catalyst layer, possessing a different water uptake and stronger adhesiveness than the core layer, and a chemical stability towards conditions during operation that is greater than the chemical stability of the core layer. This device is versatile, capable of operating as an electrolyzer, a fuel cell, or a reversible fuel cell, and is optimized for enhanced ion transport and device performance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating a multilayered membrane layer, according to certain embodiments of the present disclosure.

FIG. 2 is a block diagram illustrating a multilayered membrane layer, according to other embodiments of the present disclosure.

FIG. 3 is a schematic illustration of an AEM electrolyzer system including the multilayered membrane layer of FIGS. 1 and 2, according to certain embodiments of the present disclosure.

FIG. 4 is a flowchart illustrating a method for manufacturing an AEM electrolyzer system, according to certain embodiments of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the efficiency and functionality of electrochemical devices by introducing a multilayered membrane that includes a core layer and at least one surface layer, each with distinct properties to enhance the interface with a catalyst layer. The surface layer is engineered to exhibit at least one of a different water uptake capacity, and greater adhesiveness than the core layer, and a chemical stability towards conditions during operation that is greater than the chemical stability of the core layer, which are critical factors in improving the performance of the membrane and ensuring adequate hydration essential for ion transport. This innovative design allows for a tailored approach to meet specific application needs and performance requirements, contributing to the advancement of sustainable energy solutions through improved electrochemical device technology.

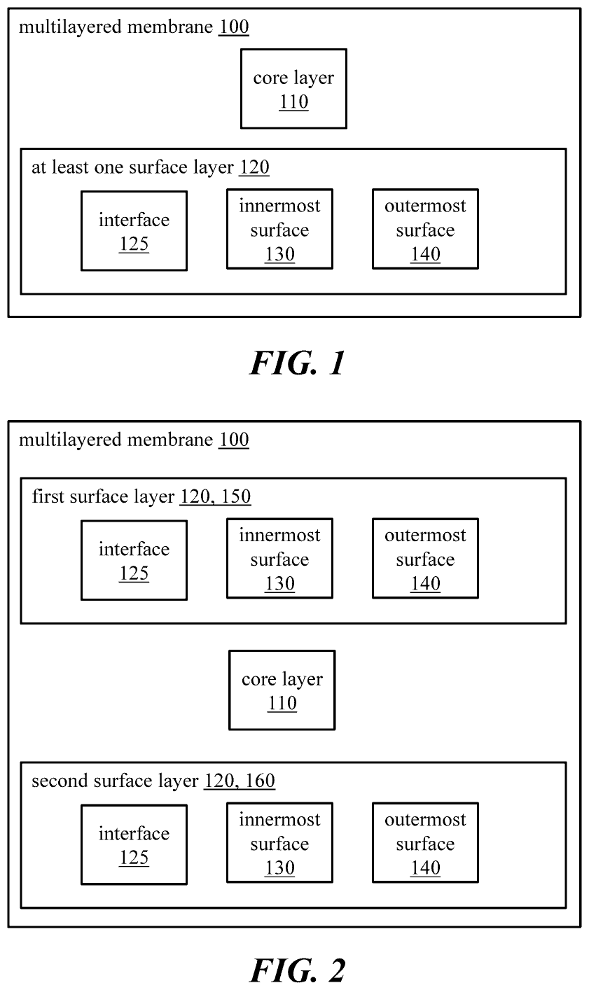

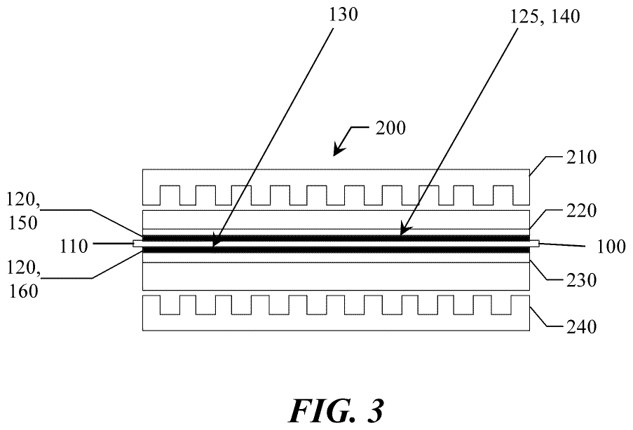

With reference to FIGS. 1-3, the present disclosure introduces a multilayered membrane 100 designed for electrochemical devices, which includes a core layer 110 and one or more surface layers 120. The surface layers may be specifically engineered to enhance an interface 125 with a catalyst layer or electrode (e.g., 220 shown in FIG. 3), characterized by a different water uptake capacity and greater adhesiveness compared to the core layer.

For the core layer 110 and the at least one surface layer 120 as described herein, and particularly where the multilayered membrane 100 may be employed in an Anion Exchange Membrane (AEM), materials specifically designed for conducting hydroxide ions, and polymer materials that offer high ionic conductivity and stability in alkaline environments may be preferred. Suitable polymers include quaternized polyolefins, such as polyethylene or polypropylene modified with quaternary ammonium groups, which facilitate the transport of hydroxide ions. Another example may be poly(phenylene oxide) (PPO), which can be functionalized with cationic groups like trimethylammonium to create pathways for hydroxyl ion conduction. These materials may be chosen for their ability to maintain structural integrity and resist swelling while providing efficient ion transport.

Additionally, hydrocarbon-based polymers such as polystyrene or polyvinyl alcohol can be modified with anion exchange functionalities to enhance hydroxyl ion conduction. Cross-linked polymers, created by cross-linking agents like poly(vinylbenzyl chloride) with tertiary amines, also serve as suitable materials for the core layer due to their dimensional stability and ability to form a robust network structure.

It should be appreciated that the at least one surface layer of the present disclosure may also contain a recombination catalyst, typically platinum as one non-limiting example, which facilitates a reaction when gas diffuses through the membrane. This reaction involves the combination of oxygen and hydrogen gases to form water, thereby advantageously militating against or preventing contamination that would otherwise be caused by their migration through the membrane. Suitable amounts and concentrations of the recombination catalyst may be selected by one skilled in the art within the scope of the present disclosure.

Furthermore, it should be noted that the at least one surface layer of the present disclosure may be selected to have specific properties depending on its position, in particular, but not limited to its chemical stability towards the conditions during operation. If it is on the anode, for example, the layer must be highly oxidation-resistant. This can be achieved by using at least partially fluorinated polymers such as polyvinylidene fluoride (PVDF), ethylene tetrafluoroethylene (ETFE), fluorinated ethylene propylene (FEP), perfluoroalkoxy alkane (PFA), or polychlorotrifluoroethylene (PCTFE). The polymers can be at least part of the backbone, side chains or cross-linking chains. These are non-limiting examples of polymers known for their excellent resistance to oxidation. For the cathode, for example, the layer needs to be highly reduction-resistant, which can be achieved using polymers such as polyphenylene sulfide (PPS), polyetheretherketone (PEEK), polytetrafluoroethylene (PTFE), or polyimide. The polymers can be at least part of the backbone, side chains or cross-linking chains. These examples also serve as non-limiting options known for their stability in reducing environments. In some instances, it should be appreciated that it may be necessary to adjust conductivity to enhance oxidation stability.

One of ordinary skill in the art may also select other suitable polymer materials, for example, as driven by the need for a balance between mechanical strength, chemical resistance, and the capacity to conduct hydroxide ions effectively within the operational parameters of the AEM, as desired.

The optimal thickness range for the surface layer in a multilayered membrane may also be selected to balance durability and ion conductivity without compromising the overall performance of the membrane. For the surface layer, a thickness range of approximately five (5) to fifty (50) micrometers may be often suitable. This range ensures that the surface layer may be thick enough to provide the necessary mechanical strength and adhesiveness to the catalyst layer, while still allowing for efficient ion transport.

For the core layer, which provides structural support and contributes to the ion exchange capacity of the membrane, a thickness range of about ten (10) to about two hundred (200) micrometers may be generally effective. This thickness ensures that the core layer maintains the necessary mechanical integrity and contributes to the overall durability of the membrane.

When considering the ratio of thicknesses between the surface layer and the core layer, a ratio of 1:2 to 1:4 (surface layer:core layer) may be often found to be suitable. This ratio allows for a robust surface layer that can effectively interface 125 with the catalyst layer while supported by a thicker core layer that provides the necessary strength and longevity for the operation of the membrane within the electrochemical device.

It should be appreciated that one of ordinary skill in the art may select specific thicknesses and ratios of thickness for the at least one surface layer and the core layer depending on the intended application, operational conditions, and the specific materials used for the surface and core layers. Therefore, these ranges and ratios should be optimized through experimental validation to meet the requirements of the particular electrochemical device and its operating environment.

With continued reference to FIGS. 1-3, the surface layer 120 may exhibit a lower degree of cross-linking than the core layer 110, contributing to the flexibility and durability of the membrane. This feature may be further defined by an innermost surface 130 that contacts the core layer and an outermost surface 140 that may be intended to contact the catalyst layer. A gradient of cross-linking density may be present from the interface 125 with the core layer to the outermost surface.

It should be appreciated that the core layer and the surface layer may be differentiated by several key factors, including the type of backbone, the functional or ionic groups present, and the amount and type of crosslinking used. Additionally, the polymers in these layers can vary in their ion exchange capacity (IEC), which is influenced by different amounts or densities of functional groups. These variations are crucial in defining the distinct properties and functionalities of each layer, as described herein.

The surface layer 120 may also have a higher ion exchange capacity (IEC) value than that of the core layer 110. This property may be critical for the ability of the membrane to conduct ions, thereby enhancing the overall efficiency of the electrochemical device.

The surface layer 120 includes a polymer that may be imbued with adhesive functional groups. These groups may be selected from epoxy, carboxyl, hydroxyl, amine, thiol, silane, and acrylate groups, all of which may be known to form strong adhesive bonds with the catalyst layer. For instance, epoxy groups can be introduced by modifying polyvinyl alcohol (PVA) with glycidyl methacrylate (GMA), which serves as the adhesive functional groups.

As also shown in FIGS. 1-3, the interface 125 between the surface layer 120 and the catalyst layer may be optimized through a strategic distribution of adhesive functional groups, ensuring maximum contact and adhesion. A gradient concentration of these groups increases towards the outermost surface of the surface layer, promoting stronger adhesion with the catalyst layer.

The surface layer 120 may also feature a nanostructured topology that allows for molecular-level interlocking with the catalyst of the catalyst layer. Surface treatments, such as plasma processes or etching, may be employed to enhance wettability and adhesion to the catalyst layer. These treatments can include plasma processes configured to increase adhesiveness or etching processes that create micro-pores or channels for mechanical interlocking with the catalyst layer.

With continued reference to FIGS. 1-3, chemical bonding between the surface layer 120 and the catalyst layer can be achieved through covalent or ionic linkages. Additionally, the surface layer may contain a catalyst-binding moiety that selectively attracts and retains the catalyst of the catalyst layer.

The design of the surface layer 120 aims to reduce interfacial resistance between the core layer 110 and the catalyst layer, thereby improving the performance of the electrochemical device. This reduction in interfacial resistance may be achieved by embedding the catalyst layer within the polymer matrix of the surface layer under applied pressure, resulting in a seamless integration of the catalyst-membrane.

The interfacial resistance of the interface 125 may be measured to be less than 5 milliohm·cm² by electrochemical impedance spectroscopy (EIS), indicating enhanced electrical connectivity with the catalyst layer. This low resistance may be critical for maintaining the structural integrity of the catalyst layer during operational stresses and thermal cycling.

The strength of the interface 125 may be quantified by peel strength tests, where the surface layer 120 demonstrates a peel strength of at least 0.5 N/mm when bonded to the catalyst layer. The surface roughness of the surface layer, which ranges from ten (10) nm to 1 μm as measured by atomic force microscopy (AFM), may be engineered to increase the effective contact area with the catalyst layer, optimizing adhesion.

Further referencing FIGS. 1-3, the interface 125 may be further characterized by a catalyst contact retention rate of at least 95% after durability testing, which involves 1000 cycles of operation under standard electrolysis conditions. Contact angle measurements reveal that the surface layer 120 has a contact angle of less than 30 degrees with respect to a catalyst ink, indicating superior wettability and adhesion properties.

The surface layer 120 may include additional features such as a thin film of conductive polymer, which acts as a primer to improve adhesiveness of the core layer to the catalyst layer. Coupling agents may be incorporated to chemically react with the catalyst layer, forming a strong and durable bond. Swelling agents may be also included to facilitate the penetration of the surface layer into the catalyst layer, enhancing the interface 125.

The surface layer 120 can be a single layer (for example, as shown in FIG. 1) or may include a first surface layer 150 and a second surface layer 160, with the core layer 110 disposed between them (for example, as shown in FIG. 2). This latter configuration may allow for a symmetrical multilayered membrane structure that can be tailored to specific operational requirements of the electrochemical device.

Referring now to FIG. 3, the multilayered membrane 100 may be integrated into an electrochemical device 200, which includes an anode plate 210, an anode electrode 220, a cathode electrode 230, and a cathode plate 240. The device may be capable of functioning as an electrolyzer, a fuel cell, or a reversible fuel cell, demonstrating the adaptability of the membrane to various electrochemical applications.

The core layer 110 of the multilayered membrane 100 may be in indirect contact with the anode electrode 220 via the surface layer 120. The multilayered membrane may be designed to enhance ion transport efficiency and may be tailored to the specific operational requirements of the electrochemical device. The device may be configured to operate within a specific pH range suitable for the multilayered membrane.

The electrochemical device may include systems for real-time monitoring of the performance of the multilayered membrane, facilitating easy replacement for maintenance, and thermal management in communication with the multilayered membrane. The device may be also designed to minimize fouling of the multilayered membrane during operation.

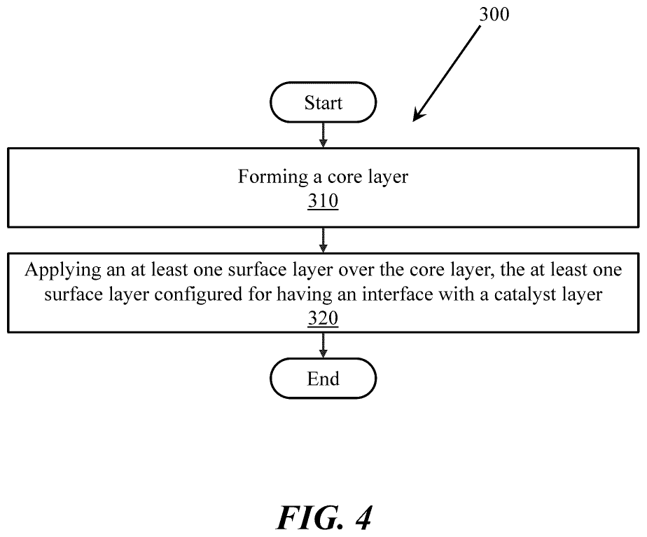

Referring now to FIG. 4, the present disclosure further includes a method 300 for manufacturing the multilayered membrane includes a series of steps 310, 320 to ensure the functionality and performance of the final product. The process begins with a step 310 of forming the core layer, which serves as the foundational component of the multilayered membrane. Upon establishing the core layer, one or more surface layers may be applied over it at step 320. These surface layers may be designed to enhance the interface 125 with the catalyst layer and exhibit different water uptake capacity and superior adhesiveness compared to the core layer. In a particular example, the surface layers may be designed to exhibit both superior water update capacity and adhesiveness.

It should be appreciated that environmental conditions may be critical in providing the water uptake capacity of materials to be employed as the surface layers. For example, if a higher water uptake capacity is desired, it may be advisable to use a cool and dry environment for the processing of the materials of the surface layers. Conversely, a hot and wet environment may be utilized if a lower water uptake capacity is preferred. In both situations, careful management of these conditions is essential to prevent over-swelling of the material of the surface layers. To incorporate the necessary adhesive functional groups into the surface layer, a selection step may be provided as part of the method 300 whereby the operator selects the suitable functional groups for the at least one surface layer beforehand. These groups may consist of epoxy, carboxyl, hydroxyl, and amine groups, which may be known for their strong bonding capabilities with the catalyst layer. The method 300 may also involve a controlled cross-linking process, for example, selectively applied to specific areas of the surface layer to achieve the desired degree of cross-linking and the associated properties.

Additionally, the method 300 may include a step of adding ion-conductive monomers to the polymer matrix of the surface layer. This step may be crucial for achieving a higher IEC value, for example, which may be indicative of the ability of the membrane to conduct ions more effectively. Where the core layer has two sides to which enhanced interfacing with the catalyst layers or electrodes is desired, the method 300 may further include a step of applying the first surface layer to one side and the second surface layer to the opposite side. This approach may result in a symmetrical multilayered membrane structure, beneficial for the uniform performance of the electrochemical device.

It should be appreciated that the method 300 of the present disclosure may be carefully designed to support all the limitations of both the independent and dependent claims, as well as the features illustrated in the drawings. Each step may be meticulously planned to ensure that the multilayered membrane meets the stringent requirements for use in various electrochemical applications, including but not limited to electrolyzers, fuel cells, and reversible fuel cells.

Advantageously, the membrane and electrochemical device of the present disclosure offer significant improvements in ion transport efficiency and operational durability due to the innovative multilayered structure of the anion exchange membrane (AEM). The surface layers, with their different water uptake capacity and enhanced adhesiveness, e.g., higher water update capacity and enhanced adhesiveness in certain embodiments, ensure optimal hydration and strong interfacing with the catalyst layer, leading to reduced interfacial resistance and increased ion exchange capacity. These features contribute to the overall performance and longevity of electrochemical devices, such as electrolyzers and fuel cells, by facilitating efficient electrolysis processes and providing the flexibility to tailor the membrane to specific application requirements, thereby promoting the development of sustainable energy solutions.

### EXAMPLES

Example embodiments of the present technology are provided with reference to the several figures enclosed herewith.

### Example 1: Application in an AEM Electrolyzer

In a particular example, the multilayered anion exchange membrane (AEM) may be integrated into an AEM electrolyzer designed for the production of hydrogen and oxygen gases. The core layer of the AEM, which may include a quaternized polyolefin, may provide structural integrity and facilitated hydroxyl ion conduction. The surface layers, engineered with a higher water uptake capacity and enhanced adhesiveness, may be optimized to interface with the catalyst layers. This design may ensure efficient ion transport and hydration, which are essential for the electrolysis process. The AEM electrolyzer constructed thusly may be provided with improved efficiency, demonstrating the adaptability of the membrane to the electrochemical environment and its ability to maintain performance over extended periods.

In this application, the lower degree of cross-linking in the surface layers of the AEM may contribute to the flexibility and durability of the membrane, allowing for better contact with the catalyst layers. The higher IEC value of the surface layers compared to the core layer may enhance the ion conductivity of the membrane, leading to an overall improvement in the operational efficiency of the electrolyzer. The AEM electrolyzer may thereby showcase the capability of the membrane to function effectively in both standard and reversible modes, highlighting its versatility across different electrochemical applications.

The performance of the AEM electrolyzer may be further enhanced by the tailored design of the membrane, which may include employment of the surface layers on both sides of the core layer. This configuration may allow for the membrane to be customized for specific performance requirements, demonstrating the potential of the present disclosure to contribute to the development of advanced sustainable energy solutions. The successful application of the multilayered AEM in the electrolyzer may thereby provide significant advancements in the field of electrochemical device technology.

### Example 2: Testing Protocols for Interface Enhancement

To determine the enhancement of the interface between the multilayered membrane and the catalyst layer, it is contemplated that several testing protocols can be employed:

Interfacial Resistance Measurement: Using Electrochemical Impedance Spectroscopy (EIS), the interfacial resistance between the membrane and the catalyst layer can be quantified. A lower interfacial resistance would indicate a better interface due to enhanced adhesion and ion transfer capabilities.

Adhesion Testing: This includes peel tests where the force required to separate the catalyst layer from the membrane is measured. A higher peel strength would suggest a stronger bond and an enhanced interface.

Surface Characterization: Techniques such as Atomic Force Microscopy (AFM) or Scanning Electron Microscopy (SEM) can be used to visualize the interface at a microscopic level. These images can reveal the degree of interlocking and the uniformity of distribution on the membrane.

Contact Angle Measurement: This test assesses the wettability of the surface of the membrane. A lower contact angle would indicate better wetting properties, suggesting that the catalyst ink can spread more effectively over the membrane, enhancing the interface.

Thermal Analysis: Differential Scanning calorimetry (DSC) and Thermogravimetric Analysis (TGA) can be used to assess the thermal properties of the interface. These tests can indicate the stability of the bond under varying thermal conditions.

### Example 3: Prophetic Example Incorporating Testing Protocols

In a further example, the multilayered AEM will be subjected to a series of tests designed to evaluate the enhancement of the interface with the catalyst layer. The first protocol will involve Electrochemical Impedance Spectroscopy (EIS) to measure the interfacial resistance. It is expected that the test will show a significant reduction in resistance compared to conventional membranes, indicating a more efficient ion transfer at the interface.

The second protocol will be a peel test, which is anticipated to demonstrate a peel strength that exceeds the industry standard for AEMs. This result will suggest that the adhesive properties of the surface layer are effectively holding the catalyst layer in place, even under mechanical stress.

For the third protocol, Atomic Force Microscopy (AFM) and Scanning Electron Microscopy (SEM) analyses will be conducted. The prophetic results are expected to show a seamless and uniform catalyst layer with no visible gaps or voids at the interface. This uniformity is predicted to contribute to the overall performance of the electrochemical device by ensuring consistent ion transport across the entire membrane surface.

The fourth protocol will involve measuring the contact angle of the membrane. The enhanced adhesion properties of the surface layer are expected to result in a contact angle significantly lower than that of traditional AEMs, indicating superior wettability and a more effective catalyst layer application.

Finally, thermal analysis through Differential Scanning calorimetry (DSC) and Thermogravimetric Analysis (TGA) will be performed. The prophetic results are expected to confirm that the interface remains stable across a wide range of temperatures, with no significant loss of adhesion or structural integrity. This stability will be critical for the performance of the membranes in varying operational conditions.

These prophetic test results are anticipated to validate the design of the multilayered AEM, demonstrating its potential to significantly improve the efficiency and durability of electrochemical devices. The enhanced interface between the membrane and the catalyst layer is expected to be a key factor in achieving these improvements.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A multilayered membrane for an electrochemical device, comprising:
a core layer; and
at least one surface layer,
wherein the at least one surface layer is configured to enhance an interface of the multilayered membrane with a catalyst layer and exhibits at least one of
a water uptake capacity that is different than the water uptake capacity of the core layer,
an adhesiveness to the catalyst layer that is greater than the adhesiveness of the core layer to the catalyst layer, and
a chemical stability towards conditions during operation that is greater than the chemical stability of the core layer.

2. The multilayered membrane of claim 1, wherein the at least one surface layer exhibits the water uptake capacity that is higher than the water uptake capacity of the core layer, and the at least one surface layer is not cross-linked or is less cross-linked than the core layer.

3. The multilayered membrane of claim 2, wherein the at least one surface layer has an innermost surface contacting the core layer and an outermost surface configured to contact the catalyst layer, and the at least one surface layer includes a gradient of cross-linking density from the interface with the core layer to the outermost surface.

4. The multilayered membrane of claim 1, wherein the at least one surface layer exhibits the water uptake capacity that is higher than the water uptake capacity of the core layer, and the at least one surface layer has a higher ion exchange capacity (IEC) value than the IEC value of the core layer.

5. The multilayered membrane of claim 1, wherein the at least one surface layer exhibits the adhesiveness to the catalyst layer that is greater than the adhesiveness of the core layer to the catalyst layer, and the at least one surface layer has a polymer with adhesive functional groups.

6. The multilayered membrane of claim 1, wherein the at least one surface layer has a nanostructured topology configured to interlock with a catalyst of the catalyst layer at a molecular level.

7. The multilayered membrane of claim 1, wherein the interface is enhanced by a surface treatment of the at least one surface layer to increase wettability and promote adhesion to the catalyst layer.

8. The multilayered membrane of claim 7, wherein the surface treatment includes at least one of:
plasma process configured to increase the adhesiveness to the catalyst layer; and
an etching process to create micro-pores or channels that increase a mechanical interlocking with the catalyst layer.

9. The multilayered membrane of claim 1, wherein an interfacial resistance between the at least one surface layer and the catalyst layer is reduced by application of pressure to embed the catalyst layer within a polymer matrix of the at least one surface layer to create a seamless catalyst-membrane integration.

10. The multilayered membrane of claim 9, wherein the interfacial resistance is less than 5 milliohm·cm², as measured by electrochemical impedance spectroscopy (EIS), indicating improved electrical connectivity with the catalyst layer.

11. The multilayered membrane of claim 1, wherein the interface is quantified by at least one of:
a peel strength test, with the at least one surface layer demonstrating a peel strength of at least 0.5 N/mm when bonded to the catalyst layer;
a surface roughness of the at least one surface layer, the surface roughness configured to increase an effective contact area with the catalyst layer, the surface roughness ranging from 10 nm to 1 μm, as measured by atomic force microscopy (AFM), to optimize adhesion to the catalyst layer;
a catalyst contact retention rate of at least 95% after a durability test involving 1000 cycles of operation under standard electrolysis conditions; and
a contact angle measurement, with the at least one surface layer exhibiting a contact angle of less than 30 degrees with respect to a catalyst ink, indicating superior wettability and adhesion properties.

12. The multilayered membrane of claim 1, wherein the at least one surface layer includes a thin film of conductive polymer coated on the core layer and which acts as a primer to improve the adhesiveness of the core layer to the catalyst layer.

13. The multilayered membrane of claim 1, wherein the at least one surface layer includes a coupling agent that chemically reacts with the catalyst layer to form a strong, durable bond.

14. The multilayered membrane of claim 1, wherein the at least one surface layer includes a swelling agent to facilitate penetration of the at least one surface layer into the catalyst layer, thereby further enhancing the interface.

15. The multilayered membrane of claim 1, wherein the at least one surface layer includes a first surface layer and a second surface layer, and the core layer is disposed between the first surface layer and the second surface layer.

16. The multilayered membrane of claim 1, wherein the at least one surface layer is a single surface layer, and the core layer has a side that directly contacts the catalyst layer or an electrode.

17. The multilayered membrane of claim 1, wherein the at least one surface layer is optimized for operation within a specific pH range.

18. A method for manufacturing a multilayered membrane, the method comprising steps of:
forming a core layer; and
applying an at least one surface layer over the core layer,
wherein the at least one surface layer is configured to enhance an interface of the multilayered membrane with a catalyst layer and exhibits at least one of
a water uptake capacity that is different than the water uptake capacity of the core layer,
an adhesiveness to the catalyst layer that is greater than the adhesiveness of the core layer to the catalyst layer, and
a chemical stability towards conditions during operation that is greater than the chemical stability of the core layer.

19. The method of claim 18, wherein the core layer has a first side and a second side, and the at least one surface layer includes a first surface layer and a second surface layer, and the method further includes a step of applying the first surface layer to the first side of the core layer and a step of applying the second surface layer to the second side of the core layer to create a symmetrical multilayered membrane structure.

20. An electrochemical device, comprising:
an anode plate;
an anode electrode;
a multilayered membrane including
a core layer, and
at least one surface layer,
wherein the at least one surface layer is configured to enhance an interface of the multilayered membrane with a catalyst layer and exhibits at least one of
a water uptake capacity that is different than the water uptake capacity of the core layer, and
an adhesiveness to the catalyst layer that is greater than the adhesiveness of the core layer to the catalyst layer, and
a chemical stability towards conditions during operation that is greater than the chemical stability of the core layer;
a cathode electrode; and
a cathode plate,
wherein the electrochemical device is configured to function as one of an electrolyzer, a fuel cell, or a reversible fuel cell.
